(19) United States
(12) Patent Application Publication
(10) Pub. No.: US 2011/0163136 A1
(43) Pub. Date: Jul. 7, 2011

(54) INFANT CARRYING DEVICE

(75) Inventor: Ulrika Billingham, Jonkoping (SE)

(73) Assignee: DREAMY DOT AB, Jonkoping (SE)

(21) Appl. No.: 13/062,796

(22) PCT Filed: Sep. 8, 2009
(86) PCT No.: PCT/SE09/00402

§ 371 Date: Mar. 8, 2011

(30) Foreign Application Priority Data
Sep. 9, 2008 (SE) 0801931-7

(51) Int. Cl. A61G 1/00

(52) U.S. Cl. 224/160

(57) ABSTRACT

An infant carrying device includes a first shawl (25) and a second shawl (26). The device includes a harness which itself includes a first band (1) and a second band (3), which cross each other, two first ends of the bands (1, 3) have a detachable connection to one another, a second end of the first band (1) is connected to the second band (3), a second end of the second band (3) is connected to the first band (1). The first band (1) is provided with two buckle parts (15A, 17A), the second band (3) is provided with two buckle parts (16A, 18A). The shawls (25, 26) at their ends are equipped with buckle parts (15B, 17B respectively 16B, 18B), and the latter parts (15B, 17B respectively 16B, 18B) can have a detachable connection with the buckle parts (15A, 17A respectively 16A, 18A) of the bands (1, 3).

### TECHNICAL FIELD OF THE INVENTION

The present invention relates to an infant carrying device, where the said device comprises a first shawl and a second shawl.

### PRIOR ART

Prior patent FR 2 371 906 describes a carrier for infants that consists of two shawls that are joined to each other at a point towards one end of each of the shawls. When in position this attachment point is located on the wearer's back and the shawls then run in a diagonal cross over the wearer's front. The second end of the first shawl is then attached to the second end of the second shawl by means of appropriate connectors such as hooks and eyes.

Prior patent DE 297 01 891 U1 describes a carrier for infants, which essentially is exactly the same as what are known as carrying shawls.

### OBJECTS AND FEATURES OF THE INVENTION

A primary object of the present invention is to present an infant carrying device that combines a harness with shawls in a way that is very wearer-friendly. In this context it should be pointed out that the carrying device according to the present invention has no limits for the minimum height or weight of the infant.

A further object of the present invention is that the carrying device can be used during a relatively long period during the infant's growth.

Another object of the present invention is that from an ergonomic perspective the infant is provided with good physical support that in turn allows for relatively long periods of carrying. The infant can adopt both reclined and seated positions.

A further object of the present invention is that the wearer is offered good ergonomic support, regardless of whether the wearer is a large or a small person.

Still another object of the present invention is that in accordance with a preferred embodiment the carrying device is made flexible so that it permits carrying both on the wearer's front and back.

At least the primary object of the present invention is realised by means of a carrying device that has been given the characterising features of the appended independent claim 1. Preferred embodiments of the invention are defined in the dependent claims.

### BRIEF DESCRIPTION OF THE DRAWINGS

The preferred embodiments of the present invention are described below, reference being made to the attached drawings, where:

FIGS. 1-4 show different views of a harness that is a part of the present invention, the harness being mounted on a wearer;

FIGS. 5-7 show frontal views of three shawls, of which at least two are included in the present invention;

FIGS. 8-11 show different views of a first embodiment of the carrying device according to the present invention, where the carrying device is worn on the front of a wearer;

FIGS. 12-15 show different views of a second embodiment of the carrying device according to the present invention, where the carrying device is worn on the front of a wearer;

FIGS. 16-18 show different views of the second embodiment of the carrying device, where the carrying device is worn on the back of a wearer;

FIGS. 19 shows a rear view of a harness, which is included in yet another embodiment of the carrying device according to the present invention; and

FIGS. 20-21 show frontal views of two shawls that are intended for use with the harness shown in FIG. 19.

### DETAILED DESCRIPTION OF THE INVENTION

The harness, illustrated in FIG. 1-4, which is part of the carrying device according to the present invention, comprises a first band 1 and a second band 3, wherein these bands 1, 3 are joined together at a point 5 where they cross each other, see FIG. 3. The two bands 1, 3 can be joined by means that defines mutually crossing channels for the bands 1, 3. The bands 1,3 are displaceable within the crossing channels. It is also conceivable that the bands 1, 3 are sewn together at the crossing point 5.

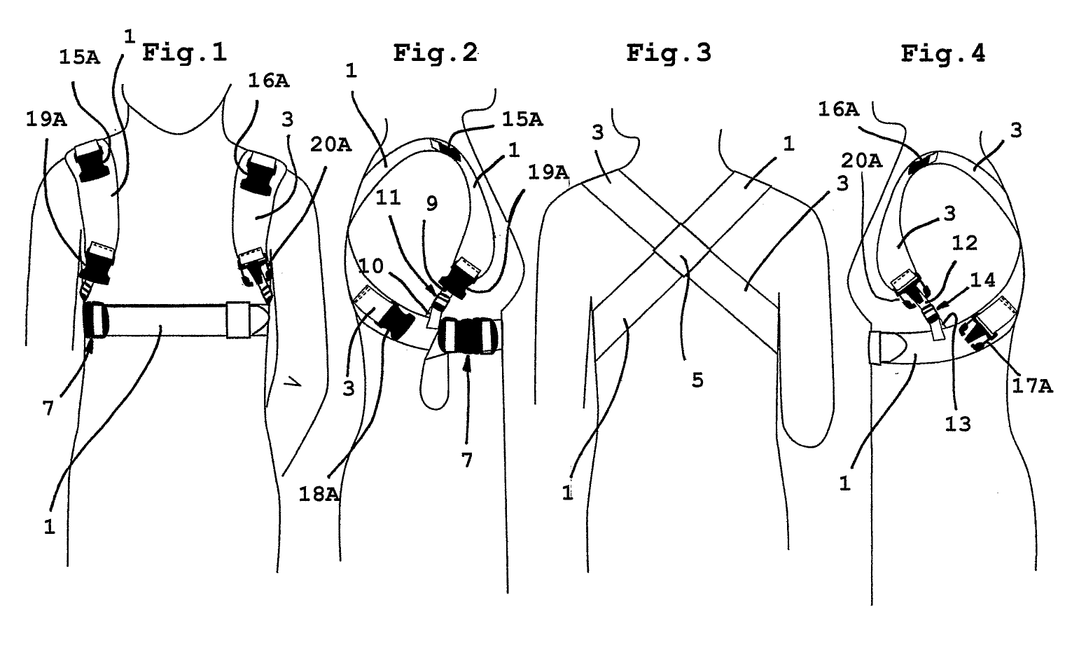

As is most clearly demonstrated by FIG. 2, one end of the first band 1 and one end of the second band 3 have a detachable connection to each other by means of a first buckle 7, which in the disclosed embodiment is located under the wearer's chest. The bands 1, 3 are connected to the parts 7A and 7B of the first buckle 7 in such a way that the lengths of the bands 1, 3 are adjustable. As is evident from FIG. 1 and FIG. 2 the first buckle 7 is located to one side of the wearer's midline for the purpose of preventing the first buckle 7 from interfering with the infant which is being carried in the carrying device of the present invention.

The end of band 1 which is not connected to the first buckle 7 is connected to the second band 3 in an area located under the wearer's shoulder when the harness is mounted on the wearer. In the disclosed embodiment the joining of the first band 1 to the second band 3 is effected by means of a first strap 9 and a second strap 10, whereby the first strap 9 is joined to the first band 1 and the second strap 10 is joined to the second band 3. The free ends of straps 9, 10 have a detachable connection with each other by means of a second buckle 11, which allows the adjustment of the combined total length of the first and second straps 9, 10. The corresponding connection of the second band 3 to the first band 1 is shown in FIG. 4, where the third and fourth straps 12, 13 have a detachable connection with each other by means of a third buckle 14.

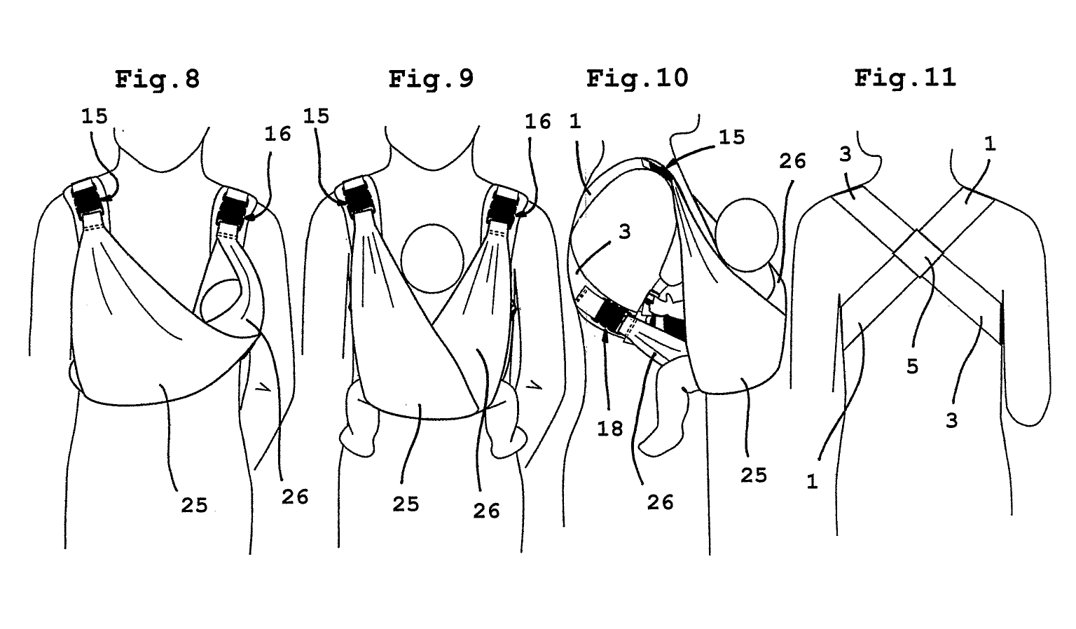

The first band 1 of the harness according to the present invention is also provided with a first part 15A of a fourth buckle 15, see FIGS. 8 and 9, and the second band 3 is provided with a first part 16A of a fifth buckle 16, see FIGS. 8 and 9. In this context it should be pointed out that, in accordance with the described embodiment, the first parts 15A and 16A can assume two diametrically opposite positions, that is to say that they can either have a forward facing orientation, see FIGS. 1 and 2, or a backward facing orientation, see FIGS. 17 and 18. The orientation of the first parts 15A, 16A is dependent upon whether the infant is to be carried on the wearer's front or back.

The first band 1 of the harness according to the present invention is also provided with a first part 17A, see FIG. 4, of a sixth buckle 17 and the second band 3 is provided with a first part 18A, see FIG. 2 of a seventh buckle 18, see FIG. 10.

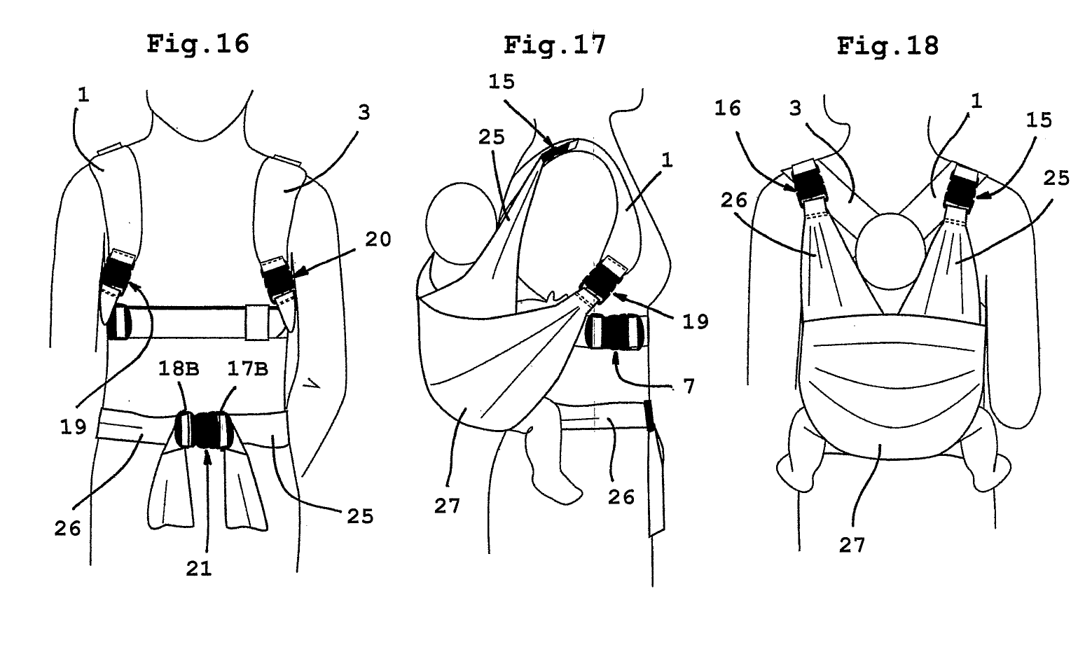

The first band 1 of the harness according to the present invention is also provided with a first part 19A of an eighth buckle 19, see FIGS. 16 and 17, and the second band 3 is provided with a first part 20A of a ninth buckle 20, see FIG. 16. In this context it should pointed out that the first parts 19A, 20A and the eighth and ninth buckles 19, 20 are only used when the infant is carried on the wearer's back. Since it is conceivable that the invention comprises a carrying device that functions only for carrying infants on the wearer's front, the first parts 19A, 20A are not obligatory.

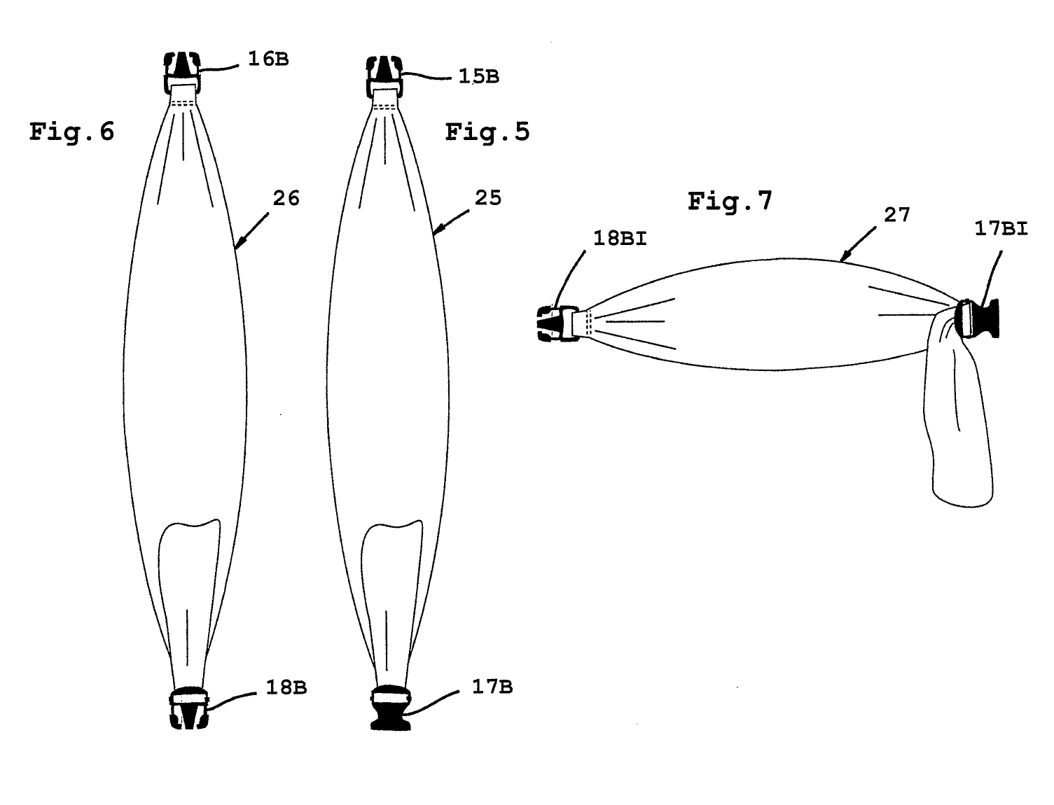

FIGS. 5-7 show frontal views of shawls that are included in the carrying device according to the present invention. The first shawl 25, shown in FIG. 5 and the second shawl 26, shown in FIG. 6, are both obligatory for the invention's concept, while the third shawl 27, shown in FIG. 7, forms part of an alternative embodiment of the carrying device according to the present invention.

In top view the basic form of shawls 25-27 is generally in the shape of a bobbin, that is to say that the shawls 25-27 have their largest width in the area of their longitudinal centre. However, the pieces of fabric that make up the shawls 25-27 are normally in the shape of elongated rectangular bands, which are gathered together at their ends, where the connection to the buckles takes place.

The first shawl 25 is provided at one end with a second part 15B of the fourth buckle 15 and is provided at the other end with a second part 17B of the sixth buckle 17.

The second shawl 26 is provided at one end with a second part 16B of the fifth buckle 16 and is provided at the other end with a second part 18B of the seventh buckle 18.

The third shawl 27 is provided at one end with a second part 17BI of the sixth buckle 17 and is provided at the other end with a second part 18BI of the seventh buckle 18. It should be noted that the second parts 17B, 17BI and 18B have an adjustable connection with their respective shawls 25, 26 and 27, that is to say that parts 17B, 17BI and 18B are displaceable along the length of shawls 25-27.

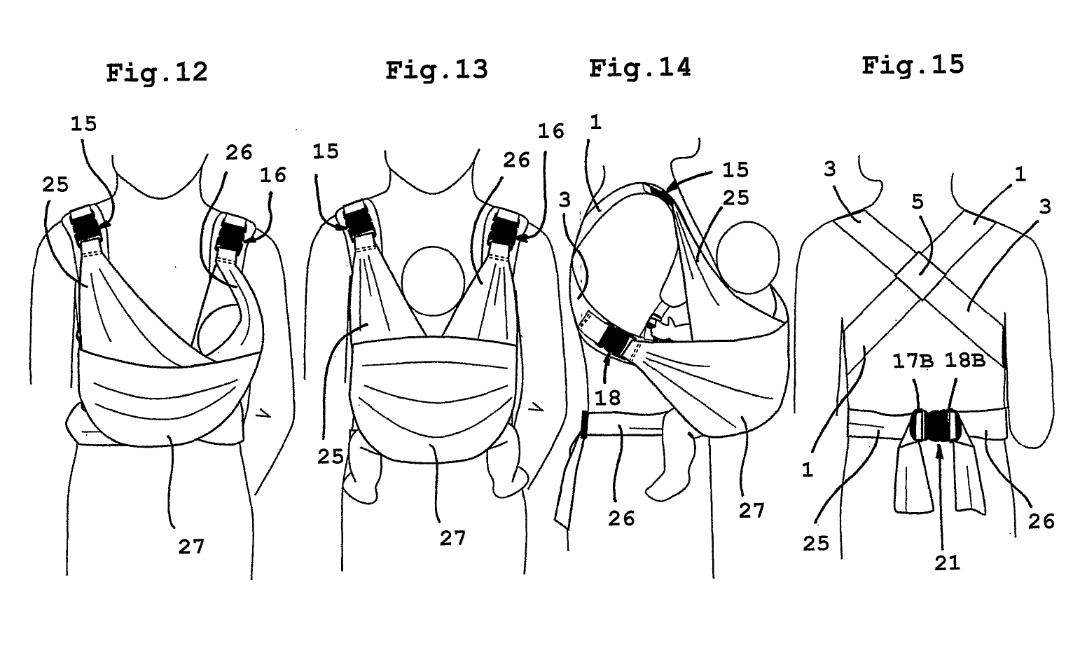

With reference to FIGS. 8-11, the use on the wearer's front of the carrying device according to the present invention will now be described. Only the first shawl 25 and the second shawl 26 are used.

Firstly the second shawl 26 is attached to the harness via the second part 16B being detachably mated with the first part 16A of the second band 3, whereby the fifth buckle 16 is established. Secondly the second part 18B is detachably mated with the first part 18A, by which the seventh buckle 18 is established. With this the second shawl 26 is correctly attached to the harness. In the same way the first shawl 25 is attached to the harness via the second part 15B being detachably mated with the first part 15A of the first band 1, whereby the fourth buckle 15 is established. Thereafter the second part 17B is detachably mated with the first part 17A, by which the sixth buckle 17 is established. With this the first shawl 25 is correctly attached to the harness. Once the shawls 25 and 26 are attached the infant can be placed accordingly in shawls 25 and 26 as illustrated in FIG. 8-10. Alternatively the wearer can hold the infant against his/her chest while they attach the shawls 25 and 26 as described above. It should be pointed out that there is an equilibrium of forces in the first band 1 and the second band 3 as the forces generated in the fourth buckle 15 and the sixth buckle 17 (not shown) of the first band 1 are in opposite directions to each other and the forces which are generated in the fifth buckle 16 and the seventh buckle 18 of the second band 3 are also in opposite directions to each other. This is ergonomically significant for the wearer since this balancing of forces prevents the movement of bands 1, 3 relative to the wearer.

FIGS. 12-15 illustrate an alternative embodiment/use of the carrying device according to the present invention. An essential difference compared to the embodiment according to FIG. 8-11 is the use of a further third shawl 27, the second part 18BI of the third shawl 27 is mated with the first part 18A of the second band 3, through which the seventh buckle 18 is established, see FIG. 14. In the corresponding way the third shawl's second part 17BI is mated with the first part 17A of the first band 1, through which the sixth buckle 17 (not shown) is established. As is shown in FIGS. 12-14 the third shawl 27, when attached to the harness, extends under the infant's seat and across the back of the infant. Another difference as regards the embodiment according to FIGS. 8-11 is that the second part 17B of the first shawl 25 is detachably mated with the second part 18B of the second shawl 26, whereby a tenth buckle 21 is established, which is located on the wearer's back at waist height. FIGS. 5 and 6 show that the second parts 17B and 18B are designed in such a way that they can be detachably mated with one another. The fourth and fifth buckles 15 and 16 are unchanged compared to the embodiment according to FIGS. 8-11. Generally, it can be stated that the embodiment according to FIGS. 12-15 is more appropriate for carrying larger infants since this particular arrangement of the shawls 25 and 26 results in the wearer taking a portion of the infant's weight in the area of the waist. The third shawl 27 brings about that an equilibrium of forces is established in the bands 1 and 3, i.e. the forces generated in the fourth buckle 15 and the sixth buckle 17 (not shown) of the first band 1 are in opposite direction to each other and those forces generated in the fifth buckle 16 and the seventh buckle 18 of the second band 3 are also in opposite direction to each other.

FIG. 16-18 illustrates yet another embodiment/use of the carrying device according to the present invention, where the infant is carried on the wearer's back.

The fourth buckle 15 and the fifth buckle 16 are orientated backwards in this embodiment, however as shown in FIGS. 12-14 the first shawl 25 is attached to the fourth buckle 15 and the second shawl 26 is attached to the fifth buckle 16. The first shawl 25 and the second shawl 26 have a detachably mated with one another via the second part 17B of the first shawl 25 which is detachably mated to the second part 18B of second shawl 26, through which a tenth buckle 21 is established on the wearer's front at waist height.

Also for this embodiment/use a third shawl 27 is included in the carrying device according to the present invention. The third shawl 27 has a second part 18BI which is detachably mated with the first part 19A of the first band 1, through which the eighth buckle 19 is established, see FIG. 17. In a corresponding way the third shawl's second part 17BI is detachably mated with the first part 20A of the second band 3, through which the twentieth buckle 20 (not shown) is established. As is shown in FIGS. 16-18 the third shawl 27, when in mounted position, runs under the infant's seat and across the infant's back.

The assistance of another person may be needed in order to place the infant in embodiment/use of the carrying device that is shown in FIGS. 16-18.

With regard to the carrying device as described above the general rule is that it offers the use of shawls that by means of quick couplings are attached to the harness of the carrying device. This results in a significant advantage when compared to the use of conventional shawls which must be completely retied every time they are to be used.

The harness shown in FIG. 19 comprises a first band 101 and a second band 103, whereby these bands 101, 103 are joined together at a point 105 where they cross each other. The bands 101, 103 can be joined by means that defines mutually crossing channels for the bands 101, 103. The bands 101, 103 are displaceable within the crossing channels. It is also conceivable that the bands 101, 103 are sewn together at the crossing point 105.

The difference in the harness between FIG. 19 and FIGS. 1-4 is that the buckles 15A and 16A have been removed from the harness in FIG. 1-4. The harness shown in FIG. 19 instead is provided with two rings 115A and 116A respectively, which are sewn onto bands 101, 103. The rings 115A and 116A can be arranged to be in diametrically opposed positions in order to allow carrying on both the wearer's front and back. According to the disclosed embodiment the rings 115A and 116A are located between the wearer's shoulders and the crossing point 105.

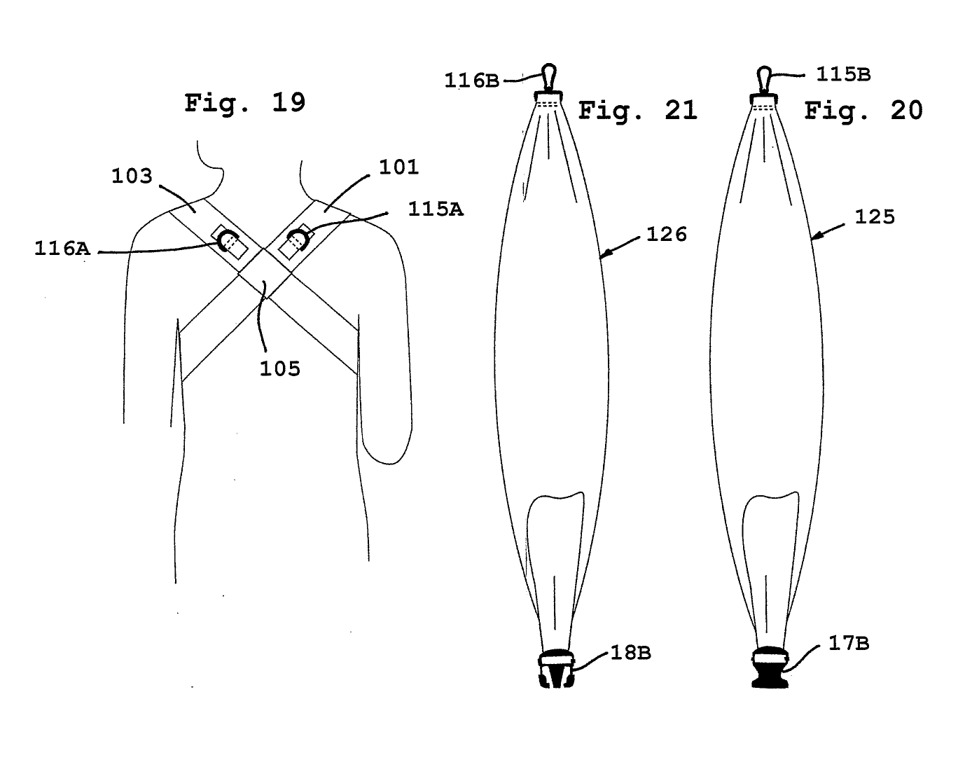

As FIGS. 20 and 21 illustrate, both shawls 125 and 126 have clips 115B and 116B at one end. These clips constitute an alternative to the buckle parts 15B and 16B of the shawls 25 and 26, see FIGS. 5 and 6. The first shawl 125 is also provided with a second part 17B of a sixth buckle 17 and the second shawl 126 is provided with a second part 18B of a seventh buckle 18. The second parts 17B and 18B can be identical with the corresponding buckle parts of the shawls 25 and 26. Therefore identical reference numerals have been used.

The use of shawls 125 and 126 will now be schematically described. Firstly, the second shawl 126 is attached to the harness via the detachable connection of the second clip 116B with the second ring 116A of the second band 103. Thereby a fifth buckle 116 is established. Since the fifth buckle 116 is located on the wearer's back the second shawl 126 can be spread over the wearer's shoulder and therefore allow an improved weight distribution. Secondly, the second part 18B is detachably mated with the first part 18A, through which a seventh buckle 18 is established. This is not shown in FIG. 19 since the seventh buckle 18 is located on the wearer's front. The second shawl 126 is now correctly mounted to the harness. In the same way the first shawl 125 is attached to the harness via the detachable connection of the first clip 115B with the first ring 115A of the first band 101, through which a fourth buckle 115 is established. Also in this case the first shawl 125 can be spread out across the wearer's shoulder. Afterwards the second part 17B is detachably mated with the first part 17A, through which the sixth buckle 17 is established. This is not shown in FIG. 19 since the sixth buckle 17 is located on the wearer's front. With this the first shawl 125 is correctly mounted on the harness.

Conceivable Modifications of the Invention

The buckles described above and shown in the drawings should only be seen as an example. Within the context of the present invention it is considered possible to use a range of different buckles that are suitable for the function required. In the present case the term “buckle” should be given a wide interpretation. In principle a buckle is defined as two parts or components which make a detachable connection one to the other.

The infant is facing towards the wearer as regards the embodiments of the invention that are described above. However, it is conceivable that the infant is facing away from the wearer when the infant is carried on the wearer's front, in which case an adjustment of shawls 25-27 may be necessary to ensure that the infant would have a comfortable sitting position.

1. An infant carrying device, wherein this device comprises a first shawl (25; 125) and a second shawl (26; 126), characterised in that the device comprises a harness comprising a first band (1; 101) and a second band (3; 103), which cross each other, that two first ends of the bands (1, 3; 101, 103) have a detachable connection with each other, that a second end of the first band (1; 101) is connected to the second band (3; 103), that a second end of the second band (3; 103) is connected to the first band (1; 101), that the first band (1; 101) is provided with two buckle parts (15A, 17A; 115A, 17A), that the second band (3, 103) is provided with two buckle parts (16A, 18A; 116A, 18A), that the shawls (25, 26; 125, 126) at their ends are equipped with buckle parts (15B, 17B respectively 16B, 18B; 115B, 17B respectively 116B, 18B), and that these latter parts (15B, 17B respectively 16B, 18B; 115B, 17B respectively 116B, 18B) can have a detachable connection with the buckle parts (15A, 17A respectively 16A, 18A; 115A, 17A respectively 116A, 18A) of the bands (1, 3; 101, 103).

2. A carrying device according to claim 1, characterised in that the buckle parts (15B, 17B; 115B, 17B) of the first shawl (25; 125) have a detachable connection with the buckle parts (15A, 17A; 115A, 17A) of the first band (1; 101), and that the buckle parts (16B, 18B; 116B, 18B) of the second shawl (26; 126) have a detachable connection with the buckle parts (16A, 18A; 116A, 18A) of the second band (3; 103).

3. A carrying device according to claim 1, characterised in that it comprises a third shawl (27) which, in the areas of its ends, is provided with buckle parts (17BI, 18BI), that these latter parts (17BI, 18BI) can have detachable connections to certain buckle parts (17A, 18A) of the bands (1, 3), and that the ends of the first and second shawls (25, 26) can have a detachable connection with each other via buckle parts (17B, 18B).

4. A carrying device according to claim 1, characterised in that the buckle parts (15B, 17B) of the first shawl (25) are a male part and a female part, and that the buckle parts (16B, 18B) of the second shawl (25) are two male parts.

5. A carrying device according to claim 4, characterised in that at least two of the buckle parts (15A, 16A) of the harness can assume two diametrically opposed positions.

6. A carrying device according to claim 5, characterised in that the first band (1) of the harness is provided with one more buckle part (19A), that the second band (3) of the harness is provided with one more buckle part (20A), that buckle parts (17BI, 18BI) of the third shawl (27) can have a detachable connection with the buckle parts (19A, 20A) of the harness.

7. A carrying device according to claim 2, characterised in that the buckle parts (15B, 17B) of the first shawl (25) are a male part and a female part, and that the buckle parts (16B, 18B) of the second shawl (25) are two male parts.

8. A carrying device according to claim 3, characterised in that the buckle parts (15B, 17B) of the first shawl (25) are a male part and a female part, and that the buckle parts (16B, 18B) of the second shawl (25) are two male parts.

9. A carrying device according to claim 7, characterised in that at least two of the buckle parts (15A, 16A) of the harness can assume two diametrically opposed positions.

10. A carrying device according to claim 8, characterised in that at least two of the buckle parts (15A, 16A) of the harness can assume two diametrically opposed positions.

11. A carrying device according to claim 9, characterised in that the first band (1) of the harness is provided with one more buckle part (19A), that the second band (3) of the harness is provided with one more buckle part (20A), that buckle parts (17BI, 18BI) of the third shawl (27) can have a detachable connection with the buckle parts (19A, 20A) of the harness.

12. A carrying device according to claim 10, characterised in that the first band (1) of the harness is provided with one more buckle part (19A), that the second band (3) of the harness is provided with one more buckle part (20A), that buckle parts (17BI, 18BI) of the third shawl (27) can have a detachable connection with the buckle parts (19A, 20A) of the harness.
